(19) United States
(12) Patent Application Publication
(10) Pub. No.: US 2004/0024086 A1
(43) Pub. Date: Feb. 5, 2004

(54) Ink composition

(75) Inventors: Hiroaki Segawa, Nagano (JP); Masaaki Itano, Nagano (JP)

Correspondence Address: William R. Evans, Ladas & Parry, 26 West 61 Street, New York, NY, 10023, US

(73) Assignee: SEIKO EPSON CORPORATION

(21) Appl. No.: 10/366,537

(22) Filed: Feb. 13, 2003

(30) Foreign Application Priority Data
Feb. 15, 2002 (JP) P.2002-039193
Mar. 14, 2002 (JP) P.2002-069735

(51) Int. Cl. C09D 11/10; C08L 9/00

(52) U.S. Cl. 523/160; 523/161; 524/571; 524/609; 524/556

(57) ABSTRACT

An ink composition comprising at least a pigment, a compound represented by the following formula (1) and/or a compound represented by the following formula (2), water, a water-soluble organic solvent and a sulfone group-containing (co) polymer:

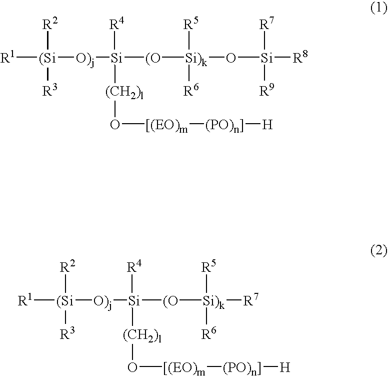

(wherein R¹ to R⁹ each independently represents a C₁₋₆ alkyl group, j and k each independently represents an integer of 1 or more, EO represents an ethylene oxy group, PO represents a propylene oxy group, 1 represents an integer of 0 or more, m and n each represents an integer of 0 or more, provided that m+n represents an integer of 1 or more, and EO and PO may be in any order within the bracket and may be present at random or form a block structure).

### FIELD OF THE INVENTION

The present invention relates to a pigment ink composition suitable for ink jet recording, which comprises a polyether-modified polysiloxane and a sulfone group-containing (co) polymer.

### BACKGROUND OF THE INVENTION

Ink jet recording is a method of recording a letter or a pattern on the surface of a recording medium by ejecting small ink droplets from fine nozzles. The ink used for such ink jet recording is required to have various properties, for example, to have high dispersion stability and good ejection stability and provide a printed matter having good scratch resistance.

The ink commonly used is obtained by dissolving a water-soluble dye of various types in an aqueous medium. Also, an ink obtained by dispersing a pigment in an aqueous medium is used. The pigment-base ink obtained by dispersing a pigment in an aqueous medium is characterized in that the water resistance and light fastness are excellent as compared with the ink using a water-soluble dye.

The dye permeates into a recording medium such as paper and is fixed. On the other hand, the pigment particle does not fundamentally permeate into a recording medium such as paper but remains thereon and forms a color. Therefore, the pigment-base ink composition is readily affected by the surface state of the recording medium. On a so-called plain paper, the pigment is unevenly fixed due to blanket of paper fibers and formation of an image having good quality is difficult to realize. Because of this, the formation of a high-quality image is realized by preparing a recording medium with a smooth and homogeneous surface, so-called special paper, and printing the image thereon using a pigment ink composition.

With the innovative progress of ink jet recording techniques in recent years, the ink jet recording method is used even in the field of high definition printing which can be heretofore realized only by silver salt photograph or offset printing. Accompanying this, an ink jet recording medium having high glossiness comparable to the photographic paper, art paper or the like conventionally used in the field of silver salt photography or offset printing is being developed. The high-gloss ink jet recording medium is predominantly produced by providing an ink-receptive layer comprising a porous pigment such as silica on a substrate such as paper or film.

However, when this ink jet special paper having an ink-receptive layer is used and solid printing is performed thereon using a conventional ink composition, a phenomenon such that the reflectance differs due to printing duty (hereinafter referred to as “uneven gloss”), a phenomenon of reddish viewing on cyan solid printing (hereinafter referred to as “bronze”), or an insufficient fixing property is caused as a problem.

On the other hand, a modified-polysiloxane compound is known as one of silicon-base surfactants. Also, some ink compositions comprising this compound are known. For example, JP-A-59-66475 (the term “JP-A” as used herein means an “unexamined published Japanese patent application”) discloses an ink composition for lithographic printing, comprising an organo-modified polysiloxane, JP-A-60-173068 discloses an ink composition comprising a modified-polysiloxane as a defoaming agent, JP-A-5-169790 and JP-A-10-310732 disclose an ink composition for ink jet recording, comprising a modified-polysiloxane having a specific structure, and JP-A-10-279871 discloses a dye-base ink composition comprising a polyether modified-polysiloxane.

### SUMMARY OF THE INVENTION

An object of the present invention is to provide an ink composition capable of realizing a good image.

In particular, the object of the present invention is to provide an ink composition which, when used in the ink jet recording method, exhibits excellent ejection stability, storage stability, color-forming property and fixing property and realizes a good image quality extremely reduced in the color bleeding, uneven printing, uneven gloss and bronze.

Other objects and effects of the present invention will become apparent from the following description.

The present invention have found that when an ink composition comprising a polyether modified-polysiloxane having a specific structure and a sulfone group-containing (co)polymer is used, a good image can be realized. The present invention has been accomplished based on this finding.

More specifically, the above-described objects of the present invention have been achieved by providing an ink composition comprising at least a pigment, a compound represented by the following formula (1) and/or a compound represented by the following formula (2), water, a water-soluble organic solvent and a sulfone group-containing (co)polymer:

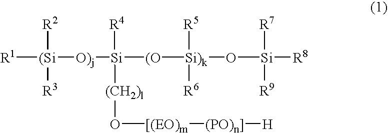

(wherein R¹ to R⁹ each independently represents a C₁₋₆ alkyl group, j and k each independently represents an integer of 1 or more, EO represents an ethylene oxy group, PO represents a propylene oxy group, 1 represents an integer of 0 or more, m and n each represents an integer of 0 or more, provided that m+n represents an integer of 1 or more, and EO and PO may be in any order within the bracket and may be present at random or form a block structure);

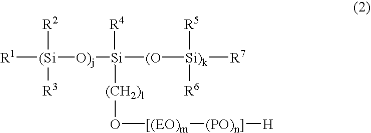

(wherein R¹ to R⁷ each independently represents a C₁₋₆ alkyl group, j and k each independently represents an integer of 1 or more, EO represents an ethylene oxy group, PO represents a propylene oxy group, 1 represents an integer of 0 or more, m and n each represents an integer of 0 or more, provided that m+n represents an integer of 1 or more, and EO and PO may be in any order within the bracket and may be present at random or form a block structure).

In one preferred embodiment of the ink composition of the present invention, the sulfone group-containing (co)polymer is blended in the form of a sulfone group-containing (co)polymer emulsion.

In another preferred embodiment of the ink composition of the present invention, the sulfone group-containing (co)polymer is a diene-base sulfone group-containing (co)polymer and/or a non-diene-base sulfone group-containing (co) polymer.

In still another preferred embodiment of the ink composition of the present invention, the non-diene-base sulfone group-containing (co)polymer is an acryl-base sulfone group-containing (co) polymer.

### DETAILED DESCRIPTION OF THE INVENTION

The ink composition of the present invention is used for recording systems using an ink composition. Examples of the recording system using an ink composition include an ink jet recording system, a recording system by a writing tool such as pen, and other various printing systems. In particular, the ink composition of the present invention is preferably used for an ink jet recording method.

According to the ink composition of the present invention, generation of uneven printing, which is often observed at the printing on plain paper using a pigment-base ink composition and is considered to be ascribable to feathers on the paper surface, a sizing agent or the like, can be effectively prevented.

Furthermore, according to the ink composition of the present invention, “uneven gloss” generated due to printing duty and “bronze” generated on cyan solid printing, which are observed at the printing on the above-described special paper using a pigment-base ink composition, can be effectively prevented.

In addition, the ink composition of the present invention is advantageous in that in the ink jet recording method, the ejection stability, storage stability, color-forming property and fixing property are excellent and a good image quality extremely reduced in the color bleeding can be realized.

The ink composition of the present invention comprises a compound represented by formula (1) and/or a compound represented by formula (2).

In formulae (1) and (2), R¹ to R⁹ each independently represents a C₁₋₆ alkyl group, preferably a methyl group; j and k each independently represents an integer of 1 or more, preferably an integer of 1 to 2; l represents an integer of o or more; and m and n each represents an integer of 0 or more, provided that m+n represents an integer of 1 or more.

According to a preferred embodiment of the present invention, the compound represented by formula (1) and the compound represented by formula (2) are preferably compounds which satisfy j=k+1. According to another preferred embodiment of the present invention, the compound represented by formula (1) and the compound represented by formula (2) are preferably compounds where R¹ to R⁹ all represent a methyl group, j represents 2, k represents 1, l represents 1, m represents an integer of 1 or more and n represents 0.

The amounts added of the compound represented by formula (1) and/or the compound represented by formula (2) may be appropriately selected but the total amount thereof is preferably from 0.03 to 3 wt %, more preferably on the order of 0.1 to 2 wt %, still more preferably on the order of 0.3 to 1 wt %, based on the weight of the ink composition.

The compound represented by formula (1) and the compound represented by formula (2) are available on the market and commercially available products can be used. Examples of the commercially available product which can be used include silicon-base surfactants BYK-345, BYK-346, BYK-348 and BYK-347 produced by Byk-Chemie Japan.

The ink composition of the present invention comprises a pigment as a colorant. Either an inorganic pigment or an organic pigment can be used. Examples of the inorganic pigment which can be used include titanium oxide, iron oxide and carbon black produced by a known method such as contact method, furnace method and thermal method. Examples of the organic pigment which can be used include azo dyes (including azo lake, insoluble azo pigment, condensed azo pigment, chelate azo pigment and the like), polycyclic pigments (e.g., phthalocyanine pigment, perylene pigment, perynone pigment, anthraquinone pigment, quinacridone pigment, dioxazine pigment, thioindigo pigment, isoindolinone pigment, quinofuranone pigment), dye chelates (e.g., basic dye-type chelate, acidic dye-type chelate), nitro pigments, nitroso pigments and aniline black.

Specific examples of the pigment include, as carbon black, No. 2300, No. 900, HCF88, No. 33, No. 40, No. 45, No. 52, MA7, MA8, MA100 and No. 2200B produced by Mitsubishi Chemical Industries, Ltd.; Raven 5750, Raven 5250, Raven 5000, Raven 3500, Raven 1255 and Raven 700 produced by Columbia; Regal 400R, Regal 330R, Regal 660R, Mogul L, Mogul 700, Monarch 800, Monarch 880, Monarch 900, Monarch 1000, Monarch 1100, Monarch 1300 and Monarch 1400 produced by Cabot; and Color Black FW1, Color Black FW2, Color Black FW2V, Color Black FW18, Color Black FW200, Color Black S150, Color Black S160, Color Black S170, Printex 35, Printex U, Printex V, Printex 140U, Special Black 6, Special Black 5, Special Black 4A and Special Black 4 produced by Degussa. These may be used individually or as a mixture of two thereof.

Specific examples of the pigment used for a yellow ink composition include C.I. Pigment Yellow 1, 2, 3, 12, 13, 14, 16, 17, 73, 74, 75, 83, 93, 95, 97, 98, 109, 110, 114, 128, 129, 138, 150, 151, 154, 155, 180 and 185. Among these, preferred are one or a mixture of two or more selected from the group consisting of C.I. Pigment Yellow 74, 109, 110, 128 and 138.

Specific examples of the pigment used for a magenta ink composition and a light magenta ink composition include C.I. Pigment Red 5, 7, 12, 48 (Ca), 48 (Mn), 57 (Ca), 15:1, 112, 122, 123, 168, 184, 202 and 209, and C.I. Pigment Violet 19. Among these, preferred are one or a mixture of two or more selected from the group consisting of C.I. Pigment Red 122, 202 and 209 and C.I. Pigment Violet 19.

Specific examples of the pigment used for a cyan ink composition and a light cyan ink composition include C.I. Pigment Blue 1, 2, 3, 15:3, 15:4, 15:34, 16, 22 and 60 and C.I. Vat Blue 4 and 60. Among these, preferred are one or a mixture of two or more selected from the group consisting of C.I. Pigment Blue 15:3, 15:4 and 60.

According to a preferred embodiment of the present invention, the pigment preferably has an average particle size of 10 to 200 nm, more preferably on the order of 50 to 150 nm.

The amount of the pigment added may be appropriately selected but is preferably from 0.1 to 20 wt %, more preferably from 0.2 to 10 wt %, based on the weight of the ink composition. In particular, the pigment content in the light magenta ink composition and the light cyan ink composition is preferably from 0.1 to 1.3 wt %, more preferably from 0.4 to 1.0 wt %.

In the present invention, the pigment is added to the ink composition as a pigment dispersion solution obtained by dispersing the pigment using a dispersant. Examples of the dispersant include a polymer dispersant and a surfactant.

Preferred examples of the polymer dispersant include natural polymers and specific examples thereof include proteins such as glue, gelatin, casein and albumin, natural rubbers such as gum arabi and tragacanth gum, glycosides such as saponin, alginic acid, alginic acid derivatives such as propylene glycol alginate, triethanolamine alginate and ammonium alginate, and cellulose derivatives such as methyl cellulose, carboxymethyl cellulose, hydroxyethyl cellulose and ethyl hydroxy cellulose.

Preferred examples of the polymer dispersant also include synthetic polymers and specific examples thereof include polyvinyl alcohols; polyvinylpyrrolidones; acryl-base resins such as polyacrylic acid, acrylic acid-acrylonitrile copolymer, potassium acrylate-acrylonitrile copolymer, vinyl acetate-acrylic acid ester copolymer and acrylic acid-alkyl acrylate copolymer; styrene-acrylic acid resins such as styrene-acrylic acid copolymer, styrene-methacrylic acid copolymer, styrene-methacrylic acid-alkyl acrylate copolymer, styrene-α-methylstyrene-acrylic acid copolymer and styrene-α-methylstyrene-acrylic acid-alkyl acrylate copolymer; styrene-maleic acid resins; styrene-maleic anhydride resins; vinylnaphthalene-acrylic acid copolymers; vinylnaphthalene-maleic acid copolymers; and vinyl acetate-base copolymers and salts thereof, such as vinyl acetate-ethylene copolymer, vinyl acetate-fatty acid vinylethylene copolymer, vinyl acetate-maleic acid ester copolymer, vinyl acetate-crotonic acid copolymer, vinyl acetate-acrylic acid copolymer. Among these, preferred are polymer compounds having a carboxyl group (preferably in the form of a salt) (for example, the above-described styrene-acrylic acid resin, styrene-maleic acid resin, styrene-maleic anhydride resin, vinylnaphthalene-acrylic acid copolymer, vinylnaphthalene-maleic acid copolymer and vinyl acetate-acrylic acid copolymer), copolymers of a monomer having a hydrophobic group and a monomer having a hydrophilic group, and polymers comprising a monomer having both a hydrophobic group and a hydrophilic group within the molecular structure. Examples of the salt include salts with diethylamine, ammonia, ethylamine, triethylamine, propylamine, isopropylamine, dipropylamine, butylamine, isobutylamine, triethanolamine, diethanolamine, aminomethylpropanol or morpholine. These copolymers preferably have a weight average molecular weight of 3,000 to 30,000, more preferably from 5,000 to 15,000.

Examples of the surfactant preferred as the dispersant include anionic surfactants such as fatty acid salts, higher alkyl dicarboxylates, higher alcohol sulfuric ester salts, higher alkyl sulfonates, condensates of a higher fatty acid and an amino acid, sulfosuccinic ester salts, naphthenates, liquid fatty oil sulfuric ester salts and alkylallylsulfonates; cationic surfactants such as fatty acid amine salts, quaternary ammonium salts, sulfonium salts and phosphonium salts; and nonionic surfactants such as polyoxyethylene alkyl ethers, polyoxyethylene alkyl esters, sorbitan alkyl esters and polyoxyethylene sorbitan alkyl esters. It will be understood by one skilled in the art that these surfactants function as a surfactant when added to the ink composition.

The sulfone group-containing (co)polymer contained in the ink composition of the present invention includes a (co)polymer obtained by sulfonating a polymer or copolymer resulting from polymerization or copolymerization of a monomer described below (see, JP-A-11-217525), a diene-base sulfone group-containing (co)polymer comprising a diene-base monomer as an essential component and being obtained by polymerizing or copolymerizing a sulfonated monomer, and a non-diene-base sulfone group-containing (co)polymer not comprising a diene monomer as an essential component.

The monomer used for obtaining the diene-base sulfone group-containing (co)polymer includes a diene-base monomer and other monomer which can be used in combination with a diene-base monomer.

The diene-base monomer is a diene-base compound having from 4 to 10 carbons and examples thereof include 1,3-butadiene, 1,2-butadiene, 1,3-pentadiene, 1,2-pentadiene, 2,3-pentadiene, isoprene, 1,2-hexadiene, 2,3-hexadiene, 1,4-hexadiene, 1,5-hexadiene, 2,3-hexadiene, 2,4-hexadiene, 2,3-dimethyl-1,3-butadiene, 2-ethyl-1,3-butadiene, 1,2-heptadiene, 1,3-heptadiene, 1,4-heptadiene, 1,5-heptadiene, 1,6-heptadiene, 2,3-heptadiene, 2,5-heptadiene, 3,4-heptadiene, 3,5-heptadiene and cycloheptadiene. These diene-base monomers may be used individually or in combination of two or more thereof.

Examples of the other monomer which can be used in combination with a diene-base monomer include aromatic monomers such as styrene, α-methylstyrene, o-methylstyrene, p-methylstyrene, m-methylstyrene and vinylnaphthalene; alkyl (meth)acrylates such as methyl (meth)acrylate, ethyl (meth)acrylate and butyl (meth)acrylate; mono- or di-carboxylic acids or dicarboxylic anhydrides, such as (meth)acrylic acid, crotonic acid, maleic acid and itaconic acid; vinyl cyan compounds such as (meth)acrylonitrile; and unsaturated compounds such as vinyl chloride, vinylidene chloride, vinyl methyl ketone, vinyl acetate, (meth)acrylamide and glycidyl (meth)acrylate. These monomers as other monomer can be used individually or in combination of two or more thereof.

In the case of using this other monomer in combination, the amount of the diene-base monomer used is preferably 0.5 wt % or more, more preferably 1 wt % or more, still more preferably 5 wt % or more, based on the entire weight of monomers used.

The diene-base (co)polymer obtained by polymerizing or copolymerizing the diene-base monomer or the diene-base monomer and the other monomer may be a (co)polymer in any polymerization form including a random copolymer and a block copolymer. Preferred examples of the (co)polymer include an isoprene homopolymer, a butadiene homopolymer, an isoprene-styrene random copolymer, an isoprene-styrene block copolymer, a styrene-isoprene-styrene ternary block copolymer, a butadiene-styrene random copolymer, a butadiene-styrene block copolymer, a styrene-butadiene-styrene block copolymer, a styrene-butadiene-styrene ternary block copolymer and an ethylene-propylene-diene ternary block copolymer. Among these, more preferred are an isoprene-styrene block copolymer, a styrene-isoprene-styrene ternary block copolymer, a butadiene-styrene block copolymer, a styrene-butadiene-styrene block copolymer and a styrene-butadiene-styrene ternary block copolymer.

The diene-base sulfone group-containing (co)polymer for use in the present invention is obtained by sulfonating the above-described diene-base (co)polymer and/or a (co)polymer resulting from partial or entire hydrogenation of residual double bonds based on the precursor monomer of the diene-base (co)polymer, according to a known sulfonation method, for example, the method described in Shin Jikken Koza (New Experiment Course), Vol. 14, III, page 1773, Nippon Kagaku Kai (compiler) or JP-A-2-227403.

The hydrogenation may also be performed after the sulfonation.

Examples of the sulfonating agent include sulfuric anhydride, sulfuric acid, chlorosulfonic acid, fuming sulfuric acid and hydrogensulfite (e.g., Li salt, Na salt, K salt, Rb salt, Cs salt).

The amount of the sulfonating agent is usually, in terms of sulfuric anhydride, from 0.005 to 1.5 mol, more preferably from 0.01 to 1.0 mol, per 1 mol in total of monomer units of the (co)polymer. If the amount of sulfonating agent is less than 0.005 mol, a (co)polymer having an objective sulfonation ratio cannot be obtained and various performances cannot be exerted, whereas if it exceeds 1.5 mol, unreacted sulfuric anhydride increases and after neutralization with an alkali, a large amount of sulfate is produced to decrease the purity.

Then, water and/or a basic compound is allowed to act on the thus-sulfonated diene-base sulfone group-containing (co)polymer. Examples of the basic compound include a hydroxide of alkali metal, an alkoxide of alkali metal, a carbonate of alkali metal, aqueous ammonia, an organic metal compound and amines. The basic compounds can be used individually or in combination of two or more thereof. The amount of the basic compound used is 2 mol or less, preferably 1.3 mol or less, per mol of the sulfonating agent used.

The diene-base sulfone group-containing (co)polymer obtained as such is preferably used in the state of being emulsified in water. The emulsification can be attained by stirring and mixing the (co)polymer, which is neutralized with water and/or a basic compound or is in the state before neutralization (namely, an organic solvent solution of the sulfonated product), with water and/or a basic compound to form an emulsion and removing the organic solvent while allowing the water to remain.

The content of the diene-base sulfone group-containing (co)polymer in the ink composition is preferably from 0.1 to 20 wt %, more preferably from 0.2 to 10 wt %. If the content is less than 0.1 wt %, sufficiently high scratch resistance may not be obtained, whereas if it is more than 20 wt %, the viscosity of the ink composition exceeds the optimal viscosity for the ink head or the ejection stability deteriorates.

Examples of the monomer used for obtaining the non-diene-base sulfone group-containing (co)polymer include vinyl monomers obtained by reacting an allylsulfonic acid, a vinylsulfonic acid or an isobutylene with sulfur trioxide, such as methacrylsulfonic acid; styrene-base monomers such as sodium p-styrenesulfonate (for example, SPIROMER, produced by Tosoh Corporation); monomers having a sulfonyl group, represented by the formula: CH₂═C(CH₃)—COO(AO)ₙSO₃Na (A: a lower alkylene group), such as methacrylic acid ester-base monomer (for example, ELEMINOL RS-30, produced by Sanyo Chemical Industries Co., Ltd.); and sodium salt, potassium salt and lithium salt of these monomers.

The non-diene-base sulfone group-containing (co)polymer may also be copolymerized with a monomer not containing a sulfone group. Examples of the other monomer which can be copolymerized include aromatic monovinyl compounds such as styrene, ethyl vinyl benzene, α-methylstyrene, fluorostyrene and vinylpyrroline; acrylic ester monomers such as butyl acrylate, 2-ethylhexyl acrylate, β-methacryloyloxyethyl hydrodiene phthalate and N,N-dimethylaminoethyl acrylate; methacrylic ester monomers such as 2-ethylhexyl methacrylate, methoxydiethylene glycol methacrylate, methoxypolyethylene glycol methacrylate, methyl methacrylate, ethyl methacrylate, butyl methacrylate, N,N-dimethylaminoethyl methacrylate and glycidyl methacrylate; vinyl cyanide compounds such as acrylonitrile and methacrylonitrile; silicon-modified monomers; and macromonomers.

Furthermore, a conjugate double bond compound such as butadiene and isoprene, a vinyl ester compound (e.g., vinyl acetate), 4-methyl-1-pentene and other α-olefin compounds may also be used. Among these copolymerizable monomers, preferred are styrene, methyl methacrylate and acrylo-nitrile.

The amount of the copolymerizable monomer used is usually from 1 to 93 wt %, preferably from 5 to 80 wt %, based on the entire weight of monomers used.

The non-diene-base sulfone group-containing (co)polymer can be obtained by radical-polymerizing the above-described sulfone group-containing monomer or other monomer copolymerizable with a sulfone group-containing monomer, for example, in a polymerization solvent such as water or organic solvent using a radical polymerization initiator, a chain transfer agent or the like. Examples of the polymerization organic solvent used for the racial polymerization include alcohols such as methanol, ethanol and isopropanol; aromatic hydrocarbons such as xylene, toluene and benzene; and aliphatic hydrocarbons such as butane, pentane, hexane, cyclohexane and heptane. Among these polymerization solvents, water and methanol are preferred.

Examples of the radical polymerization initiator include a persulfate-base initiator such as potassium persulfate, sodium persulfate and ammonium persulfate; an inorganic initiator such as hydrogen peroxide; an organic peroxide such as cumene hydroperoxide, isopropylbenzene hydroperoxide, paramethane hydroperoxide and benzoyl peroxide; and an organic initiator represented by the azo-base initiator such as azobisisobutyronitrile.

The non-diene-base sulfone group-containing (co)polymer obtained by polymerizing or copolymerizing the above-described non-diene-base monomer may be a (co)polymer in any polymerization form including a random copolymer and a block copolymer.

The non-diene-base sulfone group-containing (co)polymer for use in the present invention is preferably used in the state of being emulsified in water. The emulsification can be attained by stirring and mixing the (co)polymer, which is neutralized with water and/or a basic compound or is in the state before neutralization (namely, an organic solvent solution of the sulfonated product), with water and/or a basic compound to form an emulsion and removing the organic solvent while allowing the water to remain.

The content of the non-diene-base sulfone group-containing (co)polymer in the ink composition is preferably from 0.1 to 20 wt %, more preferably from 0.2 to 10 wt %. If the content is less than 0.1 wt %, sufficiently high scratch resistance may not be obtained, whereas if it is more than 20 wt %, the viscosity of the ink composition exceeds the optimal viscosity for the inkjet head or the ejection stability deteriorates.

The water for use in the ink composition of the present invention may be pure water or ultrapure water, such as ion-exchanged water, water purified by ultrafiltration or reverse osmosis, and distilled water. Furthermore, water sterilized by the irradiation with ultraviolet rays or by the addition of hydrogen peroxide is preferably used, because generation of molds or bacteria can be prevented during storage for a long period of time.

The water-soluble organic solvent is preferably a low boiling point organic solvent. Examples thereof include methanol, ethanol, n-propyl alcohol, iso-propyl alcohol, n-butanol, sec-butanol, tert-butanol, iso-butanol and n-pentanol. In particular, monohydric alcohols are preferred. The low boiling point organic solvent has an effect of shortening the time necessary for drying the ink. The amount of the low boiling point organic solvent added is preferably on the order of 5 wt % or less, more preferably on the order of 2 wt % or less, based on the weight of the ink composition.

According to a preferred embodiment of the present invention, the ink composition of the present invention further contains a wetting agent comprising a high boiling point organic solvent. Preferred examples of the high boiling point organic solvent include polyhydric alcohols (e.g., ethylene glycol, diethylene glycol, triethylene glycol, polyethylene glycol, polypropylene glycol, propylene glycol, 1,2,6-hexanetriol, thioglycol, hexylene glycol, glycerin, trimethylolethane, trimethylolpropane), urea, 2-pyrrolidone, N-methyl-2-pyrrolidone and 1,3-dimethyl-2-imidazolidinone. These may be used individually or as a mixture of two or more thereof. Among these, preferred are glycerin, triethylene glycol monobutyl ether, 2-pyrrolidone, ethylene glycol, diethylene glycol, triethylene glycol, polyethylene glycol, diethylene glycol monobutyl ether and urea. The amount of the high boiling point organic solvent added is preferably from 1 to 20 wt %, more preferably from 5 to 10 wt %, based on the weight of the ink composition.

According to a preferred embodiment of the present invention, the ink composition of the present invention further contains 1,2-alkanediol. The 1,2-alkanediol is preferably 1,2-C₁₋₈ alkanediol, more preferably 1,2-C₁₋₆ alkanediol, and most preferably 1,2-hexanediol. The amount of 1,2-alkanediol added may be appropriately selected but is preferably on the order of 1 to 15 wt %, more preferably on the order of 2 to 10 wt %, based on the weight of the ink composition.

According to a preferred embodiment of the present invention, the ink composition of the present invention contains a penetrant. Preferred examples of the penetrant include glycol ethers and/or acetylene glycol-base surfactants.

Specific examples of the glycol ethers for use in the present invention include ethylene glycol monomethyl ether, ethylene glycol monoethyl ether, ethylene glycol monobutyl ether, ethylene glycol monomethyl ether acetate, diethylene glycol monomethyl ether, diethylene glycol monoethyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol mono-n-butyl ether, diethylene glycol mono-t-butyl ether, 1-methyl-1-methoxybutanol, propylene glycol monomethyl ether, propylene glycol monoethyl ether, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol monomethyl ether, dipropylene glycol monoethyl ether, dipropylene glycol mono-n-propyl ether and dipropylene glycol mono-iso-propyl ether. These may be used individually or as a mixture of two or more thereof. The amount of the glycol ether added is preferably from 1 to 20 wt %, more preferably from 2 to 15 wt %, based on the weight of the ink composition.

According to a preferred embodiment of the present invention, an alkyl ether of polyhydric alcohol is used. In particular, ethylene glycol monoethyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether and triethylene glycol monobutyl ether are preferably used. Among these, triethylene glycol monobutyl ether is most preferred. The amount of the alkyl ether of polyhydric alcohol added may be appropriately selected but is preferably on the order of 1 to 10 wt %, more preferably on the order of 3 to 5 wt %, based on the weight of the ink composition.

Specific preferred examples of the acetylene glycol-base surfactant for use in the present invention include a compound represented by the following formula (3):

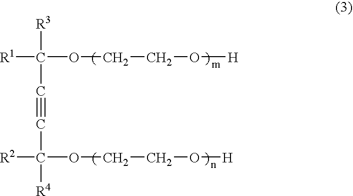

(wherein m+n is from 0 to 50, and R¹, R², R³ and R⁴ each independently represents an alkyl group (preferably an alkyl group having from 1 to 6 carbon atoms)).

Among the compounds represented by formula (3), preferred are 2,4,7,9-tetramethyl-5-decyne-4,7-diol, 3,6-dimethyl-4-octyne-3,6-diol and 3,5-dimethyl-1-hexyn-3-ol. As the acetylene glycol-base surfactant represented by formula (I), a commercially available product may also be used. Specific examples thereof include Surfynol 104, 82, 465, 485 and TG (all available from Air Products and Chemicals, Inc.), Olfin STG and Olfin E1010 (trade names, both produced by Nisshin Kagaku).

The amount of the acetylene glycol-base surfactant added may be appropriately selected but is preferably on the order of 0.1 to 10 wt %, more preferably on the order of 0.1 to 2 wt %, based on the weight of the ink composition.

According to a preferred embodiment of the present invention, a sugar is further added to the ink composition of the present invention. Specific preferred examples of the sugar include monosaccharide, disaccharide, oligo-saccharide (including trisaccharide and tetrasaccharide) and polysaccharide. Among these, preferred are glucose, mannose, fructose, ribose, xylose, arabinose, galactose, aldonic acid, glucitol, (sorbitol), maltose, cellobiose, lactose, sucrose, trehalose, maltotriose and xylitol. The “polysaccharide” as used herein means a sugar in a broad sense and includes substances widely present in the natural world, such as alginic acid, a-cyclodextrin and cellulose. Examples of the sugar derivative include reducing sugars of the above-described sugars, such as sugar alcohol (represented by formula HOCH₂(CHOH)ₙCH₂OH (wherein n represents an integer of 2 to 5)), oxidizing sugars (for example, aldonic acid and uronic acid), amino acid and thiosugar. In particular, sugar alcohols are preferred and specific examples thereof include maltitol and sorbitol.

The content of the sugar is preferably on the order of 1 to 20 wt %, more preferably on the order of 3 to 10 wt %, based on the weight of the ink composition.

The ink composition of the present invention may further contain a surfactant. Examples of the surfactant include anionic surfactants (for example, sodium dodecylbenzenesulfonate, sodium laurylsulfate and ammonium salt of polyoxyethylene alkyl ether sulfate) and nonionic surfactants (for example, polyoxyethylene alkyl ether, polyoxyethylene alkyl ester, polyoxyethylene sorbitan fatty acid ester, polyoxyethylene alkylphenyl ether, polyoxyethylene alkylamine and polyoxyethylene alkylamide). These may be used individually or in combination of two or more thereof.

The ink composition of the present invention may further contain a nozzle clogging inhibitor, an antiseptic, an antioxidant, an electrical conductivity adjusting agent, a pH adjusting agent, a viscosity adjusting agent, a surface tension adjusting agent and an oxygen absorbent.

Examples of the antiseptic and fungicide include sodium benzoate, pentachlorophenol sodium, 2-pyridinethiol-1-oxide sodium, sodium sorbate, sodium dehydroacetate and 1,2-dibenzothiazolin-3-one (Proxel CRL, Proxel BND, Proxel GXL, Proxel XL-2 and Proxel TN, produced by ICI).

Examples of the pH adjusting agent, dissolution aid and antioxidant include amines such as diethanolamine, triethanolamine, propanolamine and morpholine, and modification products thereof; inorganic salts such as potassium hydroxide, sodium hydroxide and lithium hydroxide; ammonium hydroxide; quaternary ammonium hydroxide (e.g., tetramethylammonium); carbonates such as potassium carbonate, sodium carbonate and lithium carbonate; phosphates; N-methyl-2-pyrrolidone; ureas such as urea, thiourea and tetramethylurea; allophanates such as allophanate and methyl allophanate; biurets such as biuret, dimethylbiuret and tetramethylbiuret; and L-ascorbic acids and salts thereof.

The ink composition of the present invention may also contain an antioxidant and an ultraviolet absorbent and examples thereof include Tinuvin 328, 900, 1130, 384, 292, 123, 144, 622, 770 and 292, Irgacor 252 and 153, Irganox 1010, 1076 and 1035, and MD1024, produced by Ciba-Geigy; and oxides of lanthanide.

The ink set of the present invention is a three-color ink set comprising three color ink compositions of yellow, magenta and cyan as three primary colors of the subtractive color mixture, a four-color ink set obtained by adding any one of light magenta, light cyan and black inks to the three-color ink set, a five-color ink set comprising five color ink compositions of yellow, magenta, cyan, light magenta and light cyan, or a six-color ink set obtained by adding a black ink to the five-color ink set, wherein at least one ink composition is the ink composition of the present invention.

The cartridge for ink jet recording of the present invention is obtained by housing the above-described ink composition or ink set using a conventionally known method.

The ink jet recording method of the present invention is characterized by using the ink composition or ink set of the present invention.

The aqueous ink composition of the present invention preferably has a surface tension of 20 to 45 dyn/cm, more preferably from 25 to 40 dyn/cm, at 20° C.

### Example

The present invention will be described in greater detail with reference to the following Examples, but the invention should not be construed as being limited thereto.

### 1. Preparation of Emulsion

<Emulsion 1>

(1) Dioxane (100 g) was charged into a glass-made reaction vessel, 11.8 g of acetic anhydride was added thereto while keeping the internal temperature at 25° C., and the mixture was stirred for 2 hours to obtain a sulfuric anhydride-dioxane complex.

(2) The entire amount of the complex obtained in (1) above was added to a THF solution (concentration=15%) containing 100 g of styrene/isoprene/styrene ternary block copolymer (10/80/10 by weight) while keeping the internal temperature at 25° C. and the stirring was further continued for 2 hours.

(3) Water (1,200 g), 7.1 g of sodium hydroxide and 1 g of sodium dedecylbenzenesulfonate were charged into a flask and the internal temperature was kept at 40° C. Thereto, the entire amount of the solution obtained in (2) above was added dropwise while keeping the internal temperature at 40° C. After the dropwise addition, the solution was stirred at 40° C. for 2 hours and the solvent was removed by distillation under reduced pressure while leaving water to obtain a sulfonated polymer emulsion having a concentration of 15%. The particle size of the polymer was 30 nm and the sulfonic acid content in the solid content was 1.2 mmol/g.

<Emulsion 2>

(1) 1,2-Dichloroethane (100 g) was charged into a glass-made reaction vessel and 11.8 g of sulfuric anhydride was added thereto while keeping the internal temperature at 25° C. to obtain a 1,2-dichloroethane solution of sulfuric anhydride.

(2) The entire amount of the acetic anhydride solution obtained in (1) above was added to a 1,2-dichloroethane solution (concentration=15%) containing 100 g of a hydrogenated product (hydrogenation degree: 99%) of the diene unit of a butadiene/styrene/butadiene copolymer (30/40/30 by weight) over 1 hour while keeping the internal temperature at 25° C. and the stirring was further continued for 2 hours. After the stirring, about 500 g of 1,2-dichloroethane was removed under reduced pressure and 500 g of THF was added.

(3) Water (1,200 g), 7.1 g of sodium hydroxide and 1 g of sodium dedecylbenzenesulfonate were charged into a flask and the internal temperature was kept at 40° C. Thereto, the entire amount of the solution obtained in (2) above was added dropwise while keeping the internal temperature at 40° C. After the dropwise addition, the solution was stirred at 40° C. for 2 hours and the solvent was removed by distillation under reduced pressure while leaving water to obtain a sulfonated polymer emulsion having a concentration of 15%. The particle size of the polymer was 40 nm and the sulfonic acid content in the solid content was 1.0 mmol/g.

<Emulsion 3>

In a 500 ml-volume four-neck flask with a round bottom, 0.75 g of EMAL O (alkyl sulfate-type anionic emulsifier) and 155 g of distilled water were added. After purging with nitrogen gas while slowly stirring, a 20 g portion of a mixed monomer of 40 g of vinylsulfonic acid and 40 g of methacrylic acid was added. The bath temperature was kept at 30° C. and after about 20 minutes, 10 ml of an aqueous solution containing 0.75 g of potassium persulfate and 10 ml of an aqueous solution containing 0.75 g of acidic sodium sulfite were added each in a 1/10 amount. After 30 minutes, the remaining 60 g of the mixed monomer was added dropwise over 3 hours and the polymerization initiators were also added in parts until the dropwise addition of monomer was completed. After the completion of addition, the stirring was continued for 1 hour and thereafter, the resulting polymer was salted out with 1/2 mol of an aqueous sodium sulfate solution, washed with water and then dried.

The obtained copolymer was dissolved in toluene, the toluene solution was stirred and mixed with water to emulsify the copolymer, and the toluene was removed while leaving water to obtain Emulsion 3.

### 2. Preparation of Ink Composition

### Example 1

Ink Set A

Yellow Ink Composition A:

(Pigment Dispersion Solution A)

| | |
|---|---|
| Pigment Yellow 128 | 25.0 wt % |
| Styrene-acrylic acid copolymer | 5.0 wt % |
| (dispersant resin) | |

Pigment Yellow 128 and styrene-acrylic acid copolymer (dispersant resin) were mixed with water and dispersed by zirconia beads in a sand mill (manufactured by Yasukawa Seisakusho). Thereafter, beads were removed and then the solution was centrifuged and filtered through a filter to remove coarse particles, thereby obtaining Pigment Dispersion Solution A.

Pigment Dispersion Solution A obtained and components shown below were mixed and stirred at 25° C. for 60 minutes. The mixed solution was filtered through a membrane filter of 5 μm to obtain Yellow Ink Composition A.

| | |
|---|---|
| Pigment Dispersion Solution A | 12.5 wt % |
| BYK348 | 1.0 wt % |
| 1,2-Hexanediol | 10.0 wt % |
| Glycerin | 10.0 wt % |
| Triethanolamine | 1.0 wt % |
| Emulsion 1 | 6.7 wt % |
| Pure water | balance |

Magenta Ink Composition A:

Magenta Ink Composition A was obtained in the same manner as in the preparation of Yellow Ink Composition A except for using Pigment Red 122 in place of Pigment Yellow 128.

Cyan Ink Composition A:

Cyan Ink Composition A was obtained in the same manner as in the preparation of Yellow Ink Composition A except for using Pigment Blue 15:3 in place of Pigment Yellow 128.

### Example 2

Ink Set B

Ink Set B (Yellow Ink Composition B, Magenta Ink Composition B and Cyan Ink Composition B) was obtained in the same manner as in the preparation of Ink Set A except for using Emulsion 2 in place of Emulsion 1.

### Example 3

Ink Set C

Ink Set C (Yellow Ink Composition C, Magenta Ink Composition C and Cyan Ink Composition C) was obtained in the same manner as in the preparation of Ink Set A except for using Emulsion 3 in place of Emulsion 1.

### Example 4

Ink Set D

Ink Set D (Yellow Ink Composition D, Magenta Ink Composition D and Cyan Ink Composition D) was obtained in the same manner as in the preparation of Ink Set A except for using BYK347 in place of BYK348.

### Example 5

Ink Set E

Ink Set E (Yellow Ink Composition E, Magenta Ink Composition E and Cyan Ink Composition E) was obtained in the same manner as in the preparation of Ink Set A except for using BYK347 in place of BYK348 and using Emulsion 2 in place of Emulsion 1.

### Example 6

Ink Set F

Ink Set F (Yellow Ink Composition F, Magenta Ink Composition F and Cyan Ink Composition F) was obtained in the same manner as in the preparation of Ink Set A except for using BYK347 in place of BYK348 and using Emulsion 3 in place of Emulsion 1.

### Example 7

Ink Set G

Yellow Ink Composition G:

(Pigment Dispersion Solution G)

| | |
|---|---|
| Pigment Yellow 128 | 25.0 wt % |
| Styrene-acrylic acid copolymer | 5.0 wt % |
| (dispersant resin) | |

Pigment Dispersion Solution G)

Pigment Yellow 128 and styrene-acrylic acid copolymer (dispersant resin) were mixed with water and dispersed by zirconia beads in a sand mill (manufactured by Yasukawa Seisakusho). Thereafter, beads were removed and then the solution was centrifuged and filtered through a filter to remove coarse particles, thereby obtaining Pigment Dispersion Solution G.

Pigment Dispersion Solution G obtained and components shown below were mixed and stirred at 25° C. for 60 minutes. The mixed solution was filtered through a membrane filter of 5 μm to obtain Yellow Ink Composition G.

| | |
|---|---|
| Pigment Dispersion Solution G | 12.5 wt % |
| BYK348 | 1.0 wt % |
| Olfin E1010 | 0.3 wt % |
| 1,2-Hexanediol | 10.0 wt % |
| Triethylene glycol monobutyl | 3.0 wt % |
| ether | |
| Glycerin | 10.0 wt % |
| Triethanolamine | 1.0 wt % |
| Emulsion 1 | 6.7 wt % |
| Pure water | balance |

Magenta Ink Composition G:

Magenta Ink Composition G was obtained in the same manner as in the preparation of Yellow Ink Composition G except for using Pigment Red 122 in place of Pigment Yellow 128.

Cyan Ink Composition G:

Cyan Ink Composition G was obtained in the same manner as in the preparation of Yellow Ink Composition G except for using Pigment Blue 15:3 in place of Pigment Yellow 128.

### Example 8

Ink Set H

Ink Set H (Yellow Ink Composition H, Magenta Ink Composition H and Cyan Ink Composition H) was obtained in the same manner as in the preparation of Ink Set G except for using Emulsion 2 in place of Emulsion 1.

### Example 9

Ink Set I

Ink Set I (Yellow Ink Composition I, Magenta Ink Composition I and Cyan Ink Composition I) was obtained in the same manner as in the preparation of Ink Set G except for using Emulsion 3 in place of Emulsion 1.

### Example 10

Ink Set J

Ink Set J (Yellow Ink Composition J, Magenta Ink Composition J and Cyan Ink Composition J) was obtained in the same manner as in the preparation of Ink Set G except for using BYK347 in place of BYK348.

### Example 11

Ink Set K

Ink Set K (Yellow Ink Composition K, Magenta Ink Composition K and Cyan Ink Composition K) was obtained in the same manner as in the preparation of Ink Set G except for using BYK347 in place of BYK348 and using Emulsion 2 in place of Emulsion 1.

### Example 12

Ink Set L

Ink Set L (Yellow Ink Composition L, Magenta Ink Composition L and Cyan Ink Composition L) was obtained in the same manner as in the preparation of Ink Set G except for using BYK347 in place of BYK348 and using Emulsion 3 in place of Emulsion 1.

### Comparative Example 1

Ink Set M

Yellow Ink Composition M:

(Pigment Dispersion Solution M)

| | |
|---|---|
| Pigment Yellow 128 | 25.0 wt % |
| Styrene-acrylic acid copolymer | 5.0 wt % |
| (dispersant resin) | |

Pigment Yellow 128 and styrene-acrylic acid copolymer (dispersant resin) were mixed with water and dispersed by zirconia beads in a sand mill (manufactured by Yasukawa Seisakusho). Thereafter, beads were removed and then the solution was centrifuged and filtered through a filter to remove coarse particles, thereby obtaining Pigment Dispersion Solution M.

Pigment Dispersion Solution M obtained and components shown below were mixed and stirred at 25° C. for 60 minutes. The mixed solution was filtered through a membrane filter of 5 μm to obtain Yellow Ink Composition M.

| | |
|---|---|
| Pigment Dispersion Solution M | 12.5 wt % |
| BYK348 | 0.5 wt % |
| Olfin E1010 | 0.3 wt % |
| 1,2-Hexanediol | 5.0 wt % |
| Triethylene glycol monobutyl | 3.0 wt % |
| ether | |
| Glycerin | 10.0 wt % |
| Triethanolamine | 1.0 wt % |
| Pure water | balance |

Magenta Ink Composition M:

Magenta Ink Composition M was obtained in the same manner as in the preparation of Yellow Ink Composition M except for using Pigment Red 122 in place of Pigment Yellow 128.

Cyan Ink Composition M:

Cyan Ink Composition M was obtained in the same manner as in the preparation of Yellow Ink Composition M except for using Pigment Blue 15:3 in place of Pigment Yellow 128.

### Comparative Example 2

Ink Set N

Ink Set N (Yellow Ink Composition N, Magenta Ink Composition N and Cyan Ink Composition N) was obtained in the same manner as in the preparation of Ink Set M except for using BYK347 in place of BYK348.

### Example 13

Ink Set P

Yellow Ink Composition P:

(Pigment Dispersion Solution P1)

| | |
|---|---|
| Pigment Yellow 128 | 25.0 wt % |
| Styrene-acrylic acid copolymer | 5.0 wt % |
| (dispersant resin) | |

Pigment Yellow 128 and styrene-acrylic acid copolymer (dispersant resin) were mixed with water and dispersed by zirconia beads in a sand mill (manufactured by Yasukawa Seisakusho. Thereafter, beads were removed and then the solution was centrifuged and filtered through a filter to remove coarse particles, thereby obtaining Pigment Dispersion Solution P1.

Pigment Dispersion Solution P1 obtained and components shown below were mixed and stirred at 25° C. for 60 minutes. The mixed solution was filtered through a membrane filter of 5 μm to obtain Yellow Ink Composition P.

| | |
|---|---|
| Pigment Dispersion Solution P1 | 12.5 wt % |
| BYK348 | 1.0 wt % |
| 1,2-Hexanediol | 10.0 wt % |
| Glycerin | 10.0 wt % |
| Triethanolamine | 1.0 wt % |
| Emulsion 1 | 6.7 wt % |
| Pure water | balance |

Magenta Ink Composition P:

Magenta Ink Composition P was obtained in the same manner as in the preparation of Yellow Ink Composition P except for using Pigment Red 122 in place of Pigment Yellow 128.

Cyan Ink Composition P:

Cyan Ink Composition P was obtained in the same manner as in the preparation of Yellow Ink Composition P except for using Pigment Blue 15:3 in place of Pigment Yellow 128.

Light Magenta Ink Composition P:

(Pigment Dispersion Solution P2)

| | |
|---|---|
| Pigment Yellow 122 | 25.0 wt % |
| Styrene-acrylic acid copolymer | 5.0 wt % |
| (dispersant resin) | |

Pigment Red 122 and styrene-acrylic acid copolymer (dispersant resin) were mixed with water and dispersed by zirconia beads in a sand mill (manufactured by Yasukawa Seisakusho). Thereafter, beads were removed and then the solution was centrifuged and filtered through a filter to remove coarse particles, thereby obtaining Pigment Dispersion Solution P2.

Pigment Dispersion Solution P2 obtained and components shown below were mixed and stirred at 25° C. for 60 minutes. The mixed solution was filtered through a membrane filter of 5 μm to obtain Light Magenta Ink Composition P.

| | |
|---|---|
| Pigment Dispersion Solution A | 4.0 wt % |
| BYK348 | 1.0 wt % |
| 1,2-Hexanediol | 10.0 wt % |
| Glycerin | 20.0 wt % |
| Triethanolamine | 1.0 wt % |
| Emulsion 1 | 2.2 wt % |
| Pure water | balance |

Light Cyan Ink Composition P:

Light Cyan Ink Composition P was obtained in the same manner as in the preparation of Light Magenta Ink Composition P except for using Pigment Blue 15:3 in place of Pigment Red 122.

### Example 14

Ink Set Q

Ink Set Q (Yellow Ink Composition Q, Magenta Ink Composition Q, Cyan Ink Composition Q, Light Magenta Ink Composition Q and Light Cyan Ink Composition Q) was obtained in the same manner as in the preparation of Ink Set P except for using Emulsion 2 in place of Emulsion 1.

### Example 15

Ink Set R

Ink Set R (Yellow Ink Composition R, Magenta Ink Composition R, Cyan Ink Composition R, Light Magenta Ink Composition R and Light Cyan Ink Composition R) was obtained in the same manner as in the preparation of Ink Set P except for using Emulsion 3 in place of Emulsion 1.

### Example 16

Ink Set S

Ink Set S (Yellow Ink Composition S, Magenta Ink Composition S, Cyan Ink Composition S, Light Magenta Ink Composition S and Light Cyan Ink Composition S) was obtained in the same manner as in the preparation of Ink Set P except for using BYK347 in place of BYK348.

### Example 17

Ink Set T

Ink Set T (Yellow Ink Composition T, Magenta Ink Composition T, Cyan Ink Composition T, Light Magenta Ink Composition T and Light Cyan Ink Composition T) was obtained in the same manner as in the preparation of Ink Set P except for using BYK347 in place of BYK348 and using Emulsion 2 in place of Emulsion 1.

### Example 18

Ink Set U

Ink Set U (Yellow Ink Composition U, Magenta Ink Composition U, Cyan Ink Composition U, Light Magenta Ink Composition U and Light Cyan Ink Composition U) was obtained in the same manner as in the preparation of Ink Set P except for using BYK347 in place of BYK348 and using Emulsion 3 in place of Emulsion 1.

### Example 19

Ink Set V

Yellow Ink Composition V:

(Pigment Dispersion Solution V1)

| | |
|---|---|
| Pigment Yellow 128 | 25.0 wt % |
| Styrene-acrylic acid copolymer | 5.0 wt % |
| (dispersant resin) | |

Pigment Yellow 128 and styrene-acrylic acid copolymer (dispersant resin) were mixed with water and dispersed by zirconia beads in a sand mill (manufactured by Yasukawa Seisakusho). Thereafter, beads were removed and then the solution was centrifuged and filtered through a filter to remove coarse particles, thereby obtaining Pigment Dispersion Solution V1.

Pigment Dispersion Solution V1 obtained and components shown below were mixed and stirred at 25° C. for 60 minutes. The mixed solution was filtered through a membrane filter of 5 μm to obtain Yellow Ink Composition V.

| | |
|---|---|
| Pigment Dispersion Solution V1 | 12.5 wt % |
| BYK348 | 0.5 wt % |
| Olfin E1010 | 0.3 wt % |
| 1,2-Hexanediol | 5.0 wt % |
| Ethylene glycol monobutyl ether | 3.0 wt % |
| Glycerin | 10.0 wt % |
| Triethanolamine | 1.0 wt % |
| Emulsion 1 | 6.7 wt % |
| Pure water | balance |

Magenta Ink Composition V:

Magenta Ink Composition V was obtained in the same manner as in the preparation of Yellow Ink Composition V except for using Pigment Red 122 in place of Pigment Yellow 128.

Cyan Ink Composition V:

Cyan Ink Composition V was obtained in the same manner as in the preparation of Yellow Ink Composition V except for using Pigment Blue 15:3 in place of Pigment Yellow 128.

Light Magenta Ink Composition V:

| (Pigment Dispersion Solution V2) | |
|---|---|
| Pigment Red 122 | 25.0 wt % |
| Styrene-acrylic acid copolyrner | 5.0 wt % |
| (dispersant resin) | |

Pigment Red 122 and styrene-acrylic acid copolymer (dispersant resin) were mixed with water and dispersed by zirconia beads in a sand mill (manufactured by Yasukawa Seisakusho). Thereafter, beads were removed and then the solution was centrifuged and filtered through a filter to remove coarse particles, thereby obtaining Pigment Dispersion Solution V2.

Pigment Dispersion Solution V2 obtained and components shown below were mixed and stirred at 25° C. for 60 minutes. The mixed solution was filtered through a membrane filter of 5 μm to obtain Light Magenta Ink Composition V.

| | |
|---|---|
| Pigment Dispersion Solution V2 | 4.0 wt % |
| BYK34B | 0.5 wt % |
| Olfin E1010 | 0.3 wt % |
| 1,2-Hexanediol | 5.0 wt % |
| Triethylene glycol monobutyl | 3.0 wt % |
| ether | |
| Glycerin | 20.0 wt % |
| Triethanolamine | 1.0 wt % |
| Emulsion 1 | 2.2 wt % |
| Pure water | balance |

Light Cyan Ink Composition V:

Light Cyan Ink Composition V was obtained in the same manner as in the preparation of Light Magenta Ink Composition V except for using Pigment Blue 15:3 in place of Pigment Red 122.

### Example 20

Ink Set W

Ink Set W (Yellow Ink Composition W, Magenta Ink Composition W, Cyan Ink Composition W, Light Magenta Ink Composition W and Light Cyan Ink Composition W) was obtained in the same manner as in the preparation of Ink Set V except for using Emulsion 2 in place of Emulsion 1.

### Example 21

Ink Set X

Ink Set X (Yellow Ink Composition X, Magenta Ink Composition X, Cyan Ink Composition X, Light Magenta Ink Composition X and Light Cyan Ink Composition X) was obtained in the same manner as in the preparation of Ink Set V except for using Emulsion 3 in place of Emulsion 1.

### Comparative Example 3

Ink Set Y

Yellow Ink Composition Y:

(Pigment Dispersion Solution Y1)

| | |
|---|---|
| Pigment Yellow 128 | 25.0 wt % |
| Styrene-acrylic acid copolymer | 5.0 wt % |
| (dispersant resin) | |

Pigment Yellow 128 and styrene-acrylic acid copolymer (dispersant resin) were mixed with water and dispersed by zirconia beads in a sand mill (manufactured by Yasukawa Seisakusho). Thereafter, beads were removed and then the solution was centrifuged and filtered through a filter to remove coarse particles, thereby obtaining Pigment Dispersion Solution N1.

Pigment Dispersion Solution Y1 obtained and components shown below were mixed and stirred at 25° C. for 60 minutes. The mixed solution was filtered through a membrane filter of 5 μm to obtain Yellow Ink Composition Y.

| | |
|---|---|
| Pigment Dispersion Solution Y1 | 12.5 wt % |
| BYK348 | 0.5 wt % |
| Olfin E1010 | 0.3 wt % |
| 1,2-Hexanediol | 5.0 wt % |
| Ethylene glycol monobutyl ether | 3.0 wt % |
| Glycerin | 10.0 wt % |
| Triethanolamine | 1.0 wt % |
| Pure water | balance |

Magenta Ink Composition Y:

Magenta Ink Composition Y was obtained in the same manner as in the preparation of Yellow Ink Composition Y except for using Pigment Red 122 in place of Pigment Yellow 128.

Cyan Ink Composition Y:

Cyan Ink Composition Y was obtained in the same manner as in the preparation of Yellow Ink Composition Y except for using Pigment Blue 15:3 in place of Pigment Yellow 128.

Light Magenta Ink Composition V:

(Pigment Dispersion Solution Y2)

| | |
|---|---|
| Pigment Red 122 | 25.0 wt % |
| Styrene-acrylic acid copolymer | 5.0 wt % |
| (dispersant resin) | |

Pigment Red 122 and styrene-acrylic acid copolymer (dispersant resin) were mixed with water and dispersed by zirconia beads in a sand mill (manufactured by Yasukawa Seisakusho). Thereafter, beads were removed and then the solution was centrifuged and filtered through a filter to remove coarse particles, thereby obtaining Pigment Dispersion Solution Y2.

Pigment Dispersion Solution V2 obtained and components shown below were mixed and stirred at 25° C. for 60 minutes. The mixed solution was filtered through a membrane filter of 5 μn to obtain Light Magenta Ink Composition Y.

| | |
|---|---|
| Pigment Dispersion Solution Y2 | 4.0 wt % |
| BYK348 | 0.5 wt % |
| Olfin E1010 | 0.3 wt % |
| 1,2-Hexanediol | 5.0 wt % |
| Triethylene glycol monobutyl | 3.0 wt % |
| ether | |
| Glycerin | 20.0 wt % |
| Triethanolamine | 1.0 wt % |
| Pure water | balance |

Light Cyan Ink Composition Y:

Light Cyan Ink Composition Y was obtained in the same manner as in the preparation of Light Magenta Ink Composition Y except for using Pigment Blue 15:3 in place of Pigment Red 122.

Here, BYK348 and BYK347 are silicon-base surfactants produced by Byk-Chemie Japan and these are compounds included in formulae (1) and (2), respectively. Olfin E1010 is an acetylene glycol-base surfactant produced by Nisshin Kagaku.

The ink compositions produced in Examples of the present invention each was filled in an ink jet printer EM900C (manufactured by Seiko Epson Corporation) or an ink jet printer MC2000 (manufactured by Seiko Epson Corporation) and the following evaluation tests were performed. The results obtained are shown in Table 1.

<Evaluation 1>

Using each color ink composition, printing was performed on Xerox 4024 (produced by Xerox), Xerox P (produced by Xerox) or Hanmer Mill Copy Plus (produced by Hanmer Mill) at a resolution of 720 dpi and 100% duty. The OD value in the printed area was randomly measured at 10 points by an OD value measuring apparatus (SPM-50, manufactured by GRETAG) and the results were evaluated according to the following criteria.

A: The difference in the OD value among 10 points is less than 0.05.

B: The difference in the OD value among 10 points is from 0.05 to less than 0.1.

C: The difference in the OD value among 10 points is from 0.1 to less than 0.15.

D: The difference in the OD value among 10 points is 0.15 or more.

<Evaluation 2>

The printed matters obtained in Evaluation 1 were observed with an eye and the feathering was evaluated according to the following criteria.

A: Feathering was not generated on all sheets.

B: Feathering was slightly generated only on at least one kind of sheet.

C: Whisker-like feathering was generated on all sheets.

D: On at least one kind of sheet, feathering was generated to an extent of making the contour of a letter unclear.

<Evaluation 3>

Printing was performed using the same recording paper under the same conditions as in Evaluation 1. Here, the printing was performed such that cyan, magenta and yellow came adjacently to each other, and non-uniform color bleeding at the color boundary was observed with an eye. The results were evaluated according to the following criteria.

A: Color bleeding was not generated at all on all sheets and the boundary was sharp.

B: Color bleeding was slightly generated only on at least one kind of sheet.

C:Whisker-like color bleeding was generated on all sheets.

D: On at least one kind of sheet, color bleeding was generated to an extent of making the color boundary unclear.

<Evaluation 4>

Printing was continuously performed at an ordinary temperature and the presence or absence of dot missing and ink splashing was observed. The results were evaluated according to the following criteria.

A: After passing of 72 hours, dot missing or ink splashing was generated 10 times or less.

B: In 48 to 72 hours, dot missing or ink splashing was generated 10 times.

C: In 24 to 48 hours, dot missing or ink splashing was generated 10 times.

D: In 24 hours, dot missing or ink splashing was generated 10 times.

<Evaluation 5>

The ink was filled in a printer and after confirming that printing was normally performed, printing was stopped. Thereafter, the printer was left stand at an ordinary temperature (25° C.) for 6 months. After standing, the printing was re-started and a cleaning operation was performed until printing equal to that before standing was obtained without causing any ejection failure. The number of times of the cleaning operation was evaluated according to the following criteria.

A: Printing equal to that before standing was obtained by performing the cleaning operation from 0 to 5 times.

B: Printing equal to that before standing was obtained by performing the cleaning operation from 6 to 10 times.

C: Printing equal to that before standing was not obtained even by performing the cleaning operation 11 times.

<Evaluation 6>

The ink composition (50 ml) was charged into a LABORAN screw tube bottle and left stand for 2 months in an environment of 60° C. The change in the viscosity of the ink composition between before and after standing was evaluated according to the following criteria.

A: The change in the viscosity was less than 10%.

B: The change in the viscosity was 10% or more

<Evaluation 7>

Using the magenta ink composition, printing was performed on MC photographic paper at a printing duty of 20%, 40%, 60%, 80% or 100%. The printed matter was observed with an eye from various angles and evaluated according to the following criteria.

A: Difference in the gloss was scarcely perceived even with different printing duties. B: Difference in the gloss was perceived according to different printing duties but not distinctive.

C: Difference in the gloss according to different printing duties was distinctive.

<Evaluation 8>

Using the cyan ink composition, printing was performed on MC photographic paper at a printing duty of 20%, 40%, 60%, 80% or 100%. The sample was observed with an eye from various angles and evaluated according to the following criteria.

A: Bronze was scarcely observed or mostly negligible at any printing duty.

B: Bronze was observed at one or two printing duties.

C: Bronze was observed at three or more printing duties.

TABLE 1

| | Evaluation | | | | | | | |
|---|---|---|---|---|---|---|---|---|
| | 1 | 2 | 3 | 4 | 5 | 6 | 7 | 8 |
| Ink Set A | A | A | A | A | A | A | A | A |
| Ink Set B | A | A | A | A | A | A | A | A |
| Ink Set C | A | A | A | A | A | A | A | A |
| Ink Set D | A | A | A | A | A | A | A | A |
| Ink Set E | A | A | A | A | A | A | A | A |
| Ink Set F | A | A | A | A | A | A | A | A |
| Ink Set G | A | A | A | A | A | A | A | A |
| Ink Set H | A | A | A | A | A | A | A | A |
| Ink Set I | A | A | A | A | A | A | A | A |
| Ink Set J | A | A | A | A | A | A | A | A |
| Ink Set K | A | A | A | A | A | A | A | A |
| Ink Set L | A | A | A | A | A | A | A | A |
| Ink Set M | A | A | A | A | A | A | C | B |
| Ink Set N | A | A | A | A | A | A | C | B |
| Ink Set O | A | A | A | A | A | A | A | A |
| Ink Set P | A | A | A | A | A | A | A | A |
| Ink Set Q | A | A | A | A | A | A | A | A |
| Ink Set R | A | A | A | A | A | A | A | A |
| Ink Set S | A | A | A | A | A | A | A | A |
| Ink Set T | A | A | A | A | A | A | A | A |
| Ink Set U | A | A | A | A | A | A | A | A |
| Ink Set V | A | A | A | A | A | A | A | A |
| Ink Set W | A | A | A | A | A | A | A | A |
| Ink Set X | A | A | A | A | A | A | A | A |
| Ink Set Y | A | A | A | A | A | A | C | B |

As described in detail above, the ink composition of the present invention comprises a compound represented by formula (1) and/or a compound represented by formula (2) and a sulfone group-containing (co)polymer emulsion, whereby excellent effects are provided, that is, the ejection stability, storage stability, color-forming property and fixing property are excellent and a good image extremely reduced in the color bleeding, uneven printing, uneven gloss and bronze can be recorded.

While the invention has been described in detail and with reference to specific examples thereof, it will be apparent to one skilled in the art that various changes and modifications can be made therein without departing from the spirit and scope thereof.

What is claimed is:

1. An ink composition comprising at least a pigment, a compound represented by the following formula (1) and/or a compound represented by the following formula (2), water, a water-soluble organic solvent and a sulfone group-containing (co) polymer: 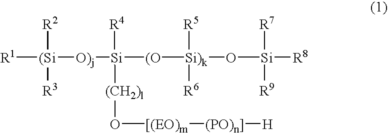
(wherein R¹ to R⁹ each independently represents a C₁₋₆ alkyl group, j and k each independently represents an integer of 1 or more, EO represents an ethylene oxy group, PO represents a propylene oxy group, 1 represents an integer of 0 or more, m and n each represents an integer of 0 or more, provided that m+n represents an integer of 1 or more, and EO and PO may be in any order within the bracket and may be present at random or form a block structure); 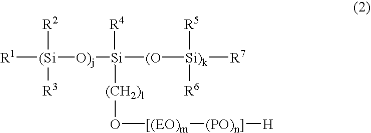
(wherein R¹ to R⁷ each independently represents a C₁₋₆ alkyl group, j and k each independently represents an integer of 1 or more, EO represents an ethylene oxy group, PO represents a propylene oxy group, 1 represents an integer of 0 or more, m and n each represents an integer of 0 or more, provided that m+n represents an integer of 1 or more, and EO and PO may be in any order within the bracket and may be present at random or form a block structure).

2. The ink composition as claimed in claim 1, wherein said compound represented by formula (1) and/or said compound represented by formula (2) satisfy j=k+1.

3. The ink composition as claimed in claim 1, wherein in said compound represented by formula (1) and/or said compound represented by formula (2), R¹ to R⁹ all represent a methyl group, j represents 2, k represents 1, 1 represents 1, m represents an integer of 1 or more, and n represents 0.

4. The ink composition as claimed in claim 1, which comprises from 0.03 to 3 wt % of said compound represented by formula (1) and/or said compound represented by formula (2).

5. The ink composition as claimed in claim 1, wherein said pigment is dispersed by a polymer compound having a carboxyl group.

6. The ink composition as claimed in claim 1, wherein said polymer compound having a carboxyl group is a styrene-acrylic acid resin.

7. The ink composition as claimed in claim 1, which comprises a 1,2-alkanediol.

8. The ink composition as claimed in claim 7, wherein said 1,2-alkanediol is 1,2-hexanediol.

9. The ink composition as claimed in claim 7, which comprises from 1 to 15 wt % of said 1,2-alkanediol.

10. The ink composition as claimed in claim 1, which comprises an alkyl ether of polyhydric alcohol.

11. The ink composition as claimed in claim 10, wherein the alkyl ether of polyhydric alcohol is ethylene glycol monoethyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether or triethylene glycol monobutyl ether.

12. The ink composition as claimed in claim 11, wherein the alkyl ether of polyhydric alcohol is triethylene glycol monobutyl ether.

13. The ink composition as claimed in claim 1, which comprises an acetylene glycol-base surfactant.

14. The ink composition as claimed in claim 13, wherein said acetylene glycol-base surfactant is represented by the following formula: 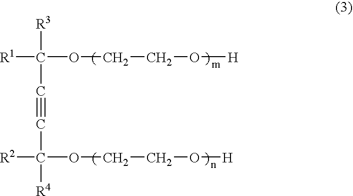
(wherein m+n is from 0 to 50, and R¹, R², R³ and R⁴ each independently represents an alkyl group).

15. The ink composition as claimed in claim 1, wherein said sulfone group-containing (co)polymer is blended in the form of a sulfone group-containing (co)polymer emulsion.

16. The ink composition as claimed in claim 1, wherein said sulfone group-containing (co)polymer is a diene-base sulfone group-containing (co)polymer and/or a non-diene-base sulfone group-containing (co)polymer.

17. The ink composition as claimed in claim 16, wherein said non-diene-base sulfone group-containing (co)polymer is an acryl-base sulfone group-containing (co) polymer.

18. The ink composition as claimed in claim 1, wherein the pigment concentration is 1.3 wt % or less based on the entire weight of the ink composition.

19. The ink composition as claimed in claim 18, which is a light magenta ink composition or a light cyan ink composition.

20. An ink set comprising the ink composition claimed in any one of claims 1 to 19.

21. An ink set comprising a yellow ink composition, a magenta ink composition and a cyan ink composition which are ink compositions claimed in any one of claims 1 to 19.

22. An ink set comprising a light magenta ink composition and a light cyan ink composition which are ink compositions claimed in any one of claims 1 to 19.

23. An ink set comprising a yellow ink composition, a magenta ink composition, a cyan ink composition, a light magenta ink composition and a light cyan ink composition which are ink compositions claimed in any one of claims 1 to 19.

24. An ink jet recording method comprising a step of performing recording by an ink jet recording method using an ink composition claimed in any one of claims 1 to 19.

25. An ink jet recording method comprising a step of performing recording by an ink jet recording method using an ink set claimed in any one of claims 20 to 23.

26. An ink cartridge housing an ink composition claimed in any one of claims 1 to 19.

27. An ink cartridge housing an ink set claimed in any one of claims 20 to 23.

28. Recorded matter, which is recorded by the ink composition claimed in any one of claims 1 to 19.

29. Recorded matter, which is recorded by the ink set claimed in any one of claims 20 to 23.
